(19) United States
(12) Patent Application Publication
(10) Pub. No.: US 2005/0036531 A1
(43) Pub. Date: Feb. 17, 2005

(54) Laser device

(75) Inventors: Hirofumi Kan, Hamamatsu-shi (JP); Akihiro Sone, Hamamatsu-shi (JP); Takunori Taira, Okazaki-shi (JP); Yasunori Furukawa, Yamanashi (JP)

Correspondence Address: MORGAN LEWIS & BOCKIUS LLP, 1111 PENNSYLVANIA AVENUE NW, WASHINGTON, DC, 20004, US

(73) Assignees: HAMAMATSU PHOTONICS K.K.; NATIONAL INSTITUTES OF NATURAL SCIENCES OKAZAKI ADMINISTRATION OFFICE; OXIDE CORPORATION

(21) Appl. No.: 10/892,475

(22) Filed: Jul. 16, 2004

(30) Foreign Application Priority Data
Jul. 16, 2003 (JP) P2003-275522

(51) Int. Cl. H01S 3/091

(52) U.S. Cl. 372/70

(57) ABSTRACT

A laser device 1 is provided with: a solid sate laser medium made of GdVO₄ or YVO₄ to which Nd³⁺ is added, having first and second surfaces 10A, 10B facing each other; a high reflection film 12 formed on the first surface of the laser medium for reflecting light having a wavelength in a first wavelength range 880±5 nm and in a second wavelength range from 910 nm to 916 nm; a reflecting means 20 placed in a manner where an optical resonator of which the resonance Q-value for light having a wavelength in the second wavelength range is greater than the resonance Q-value for light of every wavelength in a third wavelength range from 1060 nm to 1065 nm is formed together with the high reflection film and the laser medium is positioned within the resonator; and an excitation light source 22 that outputs light having a wavelength in the first wavelength range for exciting the laser medium. Laser device 1 is formed so that light from the excitation light source is guided into the resonator in a direction different from the optical axis direction of the resonator, and enters into the laser medium. As a result, a solid state laser device having a high light-emission efficiency can be implemented.

### BACKGROUND OF THE INVENTION

1. Field of the Invention

The present invention relates to a laser device and, in particular, to a solid state laser device.

2. Related Background of the Invention

Conventionally, YAG (Nd: YAG) to which Nd is doped has been used as a solid state laser medium in a solid state laser device, in particular, in an LD pump solid state laser. In the case where Nd: YAG is used as a laser medium, the laser device is designed so as to excite the laser medium with light having a wavelength of approximately 808 nm so as to gain the oscillation of light having a wavelength of approximately 1064 nm, of which the gain is the largest. In addition, it is known that in the case where a vanadate-based material such as GdVO₄ (Nd: GdVO₄) or YVO₄ (Nd: YVO₄) to which Nd is doped is used as a solid state laser medium, an increase in the light-emission efficiency can be expected because the excitation light absorption cross-section becomes greater than that of Nd: YAG. A laser device that is excited by light having a wavelength of approximately 808 nm using GdVO₄ (Nd: GdVO₄) to which Nd is doped as a solid state laser medium is disclosed as a laser device that uses a vanadate-based material as described above in, for example, Document 1 (Chenlin Du, et al., “Continuous-wave and passively Q-switched Nd: GdVO₄ lasers at 1.06 μm end-pumped by laser-diode-array”, Optics & Laser Technology 34, pp. 699-702 (2002)).

### SUMMARY OF THE INVENTION

In the case where Nd: YAG, Nd: GdVO₄ and Nd: YVO₄ are respectively excited by light having a wavelength of approximately 808 nm, electrons in the solid state laser medium are excited from the ground level to an energy level that is higher than the upper laser level. Concretely speaking, an example of Nd: YAG described as a solid state laser medium in reference to FIG. 9. Here, FIG. 9 is a schematic view showing the energy levels of Nd: YAG. When light having a wavelength of approximately 808 nm enters into the solid state laser medium, electrons in the solid state laser medium are excited from ground level ⁴I_{9/2} to energy level ⁴F_{5/2}, which is higher than upper laser level ⁴F_{5/2}. Then, the electrons move from energy level ⁴F_{5/2} to upper laser level ⁴F_{3/2} through non-radiation transition process A. Therefore, nearly 30% of the energy of the excitation light becomes the energy involved with non-radiation transition process A that does not contribute to light emission. Accordingly, an increase in the efficiency of laser oscillation is prevented, and at the same time, a problem with heat is caused in the case where an increase in the output of the laser device is attempted.

The present invention is provided in view of the above-described matters, and an object thereof is to provide a laser device which is a solid state laser device and has a high light-emission efficiency.

The present inventors have diligently continued research in order to solve the above-described problem, and have found that efficiency can be improved to a great extent by directly exciting the solid state laser medium to the upper laser level with light having a wavelength of approximately 885 nm in the case where Nd: YAG is used as a laser medium. In addition, the present inventors have focused attention on the existence of a line with intense light-emission of a wavelength of approximately 946 nm in Nd: YAG, and have examined that the solid state laser medium made of Nd: YAG can be excited with light having a wavelength of approximately 885 nm so as to oscillate light having a wavelength of approximately 946 nm.

A solid state laser medium is in general placed within an optical resonator formed of a pair of reflecting mirrors. In addition, an end surface excitation system where excitation light enters into an end surface of a laser medium, which is a solid state laser medium, at approximately the same axis as the optical axis of the optical resonator is adopted in the laser device. Therefore, in the case where the solid state laser medium is excited with light having a wavelength of approximately 885 nm, and light having a wavelength of approximately 946 nm is oscillated, it is necessary to apply a coating for allowing light having a wavelength of approximately 885 nm to pass through the pair of reflecting mirrors that form the optical resonator, while allowing light having a wavelength of approximately 946 nm to reflect from the pair of reflecting mirrors. Here, the wavelength of the excitation light and the wavelength of the oscillated light are close in value, and therefore, it is difficult to apply a coating for allowing light having a wavelength of 885 nm to pass efficiently and allowing light having a wavelength of 946 nm to be reflected, thus causing a problem where the entire efficiency of the laser device is reduced and the cost of coating becomes high.

In addition, the present inventors have diligently continued research on a laser medium that uses a vanadate-based material so that a further increase in efficiency can be expected due to a greater induced emission cross-section and excitation light absorption cross-section than those of Nd: YAG. And, the inventors have found that in the case where Nd: GdVO₄ and Nd: YVO₄ are used as a laser medium, they can be directly excited to the upper laser level with light having a wavelength of approximately 880 nm. However, the centers of light-emission in Nd: GdVO₄ and Nd: YVO₄ are wavelengths of approximately 912 nm and approximately 914 nm, respectively, having a difference of approximately 32 nm vis-à-vis the wavelength (approximately 880 nm) of the excitation light. Therefore, though a larger increase in efficiency can be expected than in the case of Nd: YAG, it is more difficult to carry out a laser oscillation according to a conventional end surface excitation method than in the case of Nd: YAG. The present invention is provided in view of these matters.

That is to say, the laser device according to the present invention is provided with: a solid state laser medium made of GdVO₄ or YVO₄ to which Nd³⁺ is added, having first and second surfaces facing each other; a high reflection film formed on the first surface of the solid state laser medium for reflecting light having a wavelength in a first wavelength range of 880±5 nm, and light having a wavelength in a second wavelength range from 910 nm to 916 nm; a reflecting means that is placed in a manner where an optical resonator of which the Q-value of the resonance for light having a wavelength in the second wavelength range is greater than the Q-value of the resonance for light of every wavelength in a third wavelength range from 1060 nm to 1065 nm is formed, together with the high reflection film, and the solid state laser medium is positioned within the optical resonator; and an excitation light source that outputs light of a wavelength in the first wavelength range for exciting the solid state laser medium, wherein light from the excitation light source is guided into the optical resonator in a direction different from the direction of the optical axis of the optical resonator so as to enter into the solid state laser medium.

In the above-described configuration, when light in the first wavelength range of 880±5 nm enters into the solid state laser medium, the solid state laser medium is directly excited to the upper laser level so that light having a wavelength in the second wavelength range (for example, a wavelength of approximately 912 nm or a wavelength of approximately 914 nm) and light having a wavelength in the third wavelength range (for example, a wavelength of approximately 1064 nm) are spontaneously emitted. Then, in the optical resonator, since the Q-value of the optical resonator for light having a wavelength in the second wavelength range is greater than the Q-value of the optical resonator for light of every wavelength in the third wavelength range, an induced emission occurs for light having a wavelength in the second wavelength range. Accordingly, light having a wavelength in the second wavelength range is outputted as a laser beam. In addition, in the above-described laser device, light from the excitation light source (excitation light) is guided into the optical resonator in a direction that is different from the direction of the optical axis of the optical resonator, so as to excite the solid state laser medium. Therefore, even in the case where the wavelength of the excitation light and the wavelength of the oscillated light are close in value, the formation of the high reflection film that forms the optical resonator, together with the reflecting means, is easy.

In addition, it is desirable for the above-described laser device to be provided with an anti reflection film formed on the second surface of the solid state laser medium for transmitting light having a wavelength in the first wavelength range and light having a wavelength in the second wavelength range. In this case, there is an anti reflection film having the above-described properties on the second surface of the solid state laser medium, and therefore, light having a wavelength in the first wavelength range and in the second wavelength range easily repeats reflections between the high reflection film and the reflecting means that forms the optical resonator, in comparison with light having a wavelength in the third wavelength range. Accordingly, it is possible to output light having a wavelength in the second wavelength range as a laser beam more efficiently.

In the above-described laser device, it is preferable for the Q-value of the resonance for light having a wavelength in the second wavelength range in the optical resonator to be 10 or more times greater than the Q-value of the resonance for light of every wavelength in the third wavelength range in the optical resonator. As a result of this, light having a wavelength in the second wavelength range can be outputted as a laser beam efficiently and securely.

In addition, it is preferable for the concentration of Nd³⁺ in the solid state laser medium to be no greater than 3 at. %. In this case, the excitation light is absorbed more efficiently, and therefore, an increase in the efficiency of the laser oscillation becomes possible.

In addition, it is desirable for the above-described laser device to be provided with an optical fiber for guiding light from the excitation light source to the optical resonator. In this case, there is increased freedom of the position of the excitation light source when the excitation light source is placed within the laser device. In addition, it is preferable for the laser device to be provided with a condensing optical system for condensing light from the excitation light source onto the solid state laser medium.

Furthermore, in the laser device, it is desirable for the angle between the direction of light from the excitation light source entering into the solid state laser medium and the optical axis of the optical resonator is no less than 5°.

In addition, it is preferable for the laser device to be provided with a optical path changing element, which is placed on the optical axis within the optical resonator, for changing the optical path of light from the excitation light source that has been guided into the optical resonator so that the light from the excitation light source enters into the solid state laser medium at approximately the same axis as the optical axis of the optical resonator.

In addition, in the laser device, it is effective for the length of the solid state laser medium relative to the optical axis of the optical resonator to be no greater than 3 mm from the point of view of oscillation efficiency and radiation of heat.

In addition, it is desirable for the laser device to be provided with a pulse generation element, which is placed on the optical path of the light that is emitted from the solid state laser medium, for generating a pulse light from the light that is emitted from the solid state laser medium. As a result of this, it is possible to output a pulse light from the laser device. Here, a saturable absorber, a photo-acoustic element, an electro-optic element and the like are cited as examples of the pulse generation element.

Moreover, it is desirable for the laser device to be provided with a non-linear optical element, which is placed on the optical path of the light that is emitted from the solid state laser medium, for generating light having a wavelength that is different from the wavelength of the light that is emitted from the solid state laser medium by means of a non-linear optical effect from the light that is emitted from the solid state laser medium. In this case, it is possible for the laser device to output light having a wavelength that is different from the wavelength of light that is spontaneously emitted by the solid state laser medium. Here, a parametric process, a sum frequency generating process, a differential frequency generating process and a higher harmonics generating process are cited as examples of the non-linear optical effect.

### BRIEF DESCRIPTION OF THE DRAWINGS

FIG. 1 is a schematic diagram showing the configuration of a laser device according to one embodiment of the present invention;

FIG. 2 is a schematic diagram showing the configuration of a laser device according to another embodiment obtained by modifying the laser device shown in FIG. 1;

FIG. 3 is a schematic diagram showing the configuration of a laser device according to still another embodiment obtained by modifying the laser device shown in FIG. 1;

FIG. 4 is a schematic diagram showing the configuration of a laser device according to still another embodiment obtained by modifying the laser device shown in FIG. 1;

FIG. 5 is a schematic diagram showing the configuration of a laser device according to still another embodiment obtained by modifying the laser device shown in FIG. 1;

FIG. 6 is a schematic diagram showing the configuration of a laser device according to still another embodiment obtained by modifying the laser device shown in FIG. 1;

FIG. 7 is a schematic diagram showing the configuration of a laser device according to still another embodiment obtained by modifying the laser device shown in FIG. 1;

FIG. 8 is a schematic diagram showing the configuration of a laser device according to still another embodiment obtained by modifying the laser device shown in FIG. 1; and

FIG. 9 is a schematic diagram showing the energy levels of Nd: YAG.

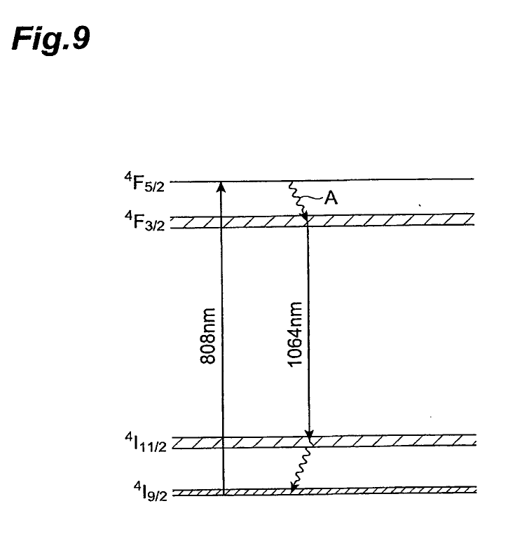

### BRIEF DESCRIPTION OF THE PREFERRED EMBODIMENTS

In the following, the laser devices according to the preferred embodiments of the present invention are described in detail in reference to the drawings. Here, the same symbols are attached to the same elements in the illustrations of the drawings, and thus the same explanations are omitted. In addition, the proportions of the dimensions in the drawings do not necessarily correspond to those in the descriptions.

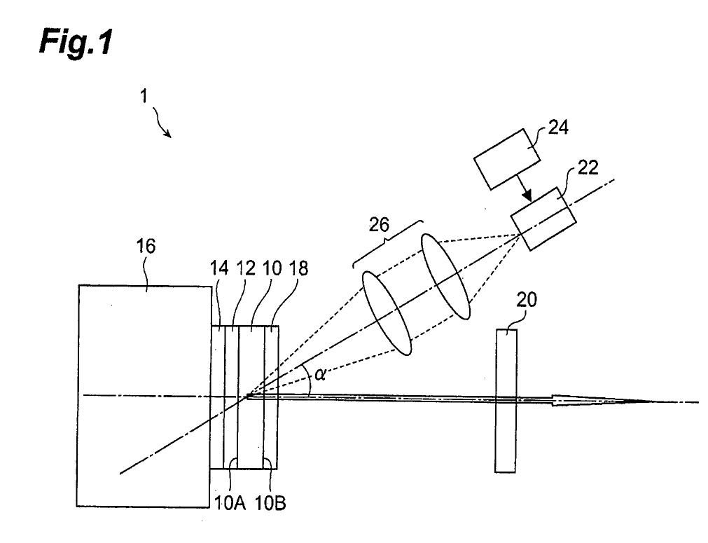

FIG. 1 is a schematic diagram showing the configuration of the laser device according to the present embodiment. A solid state laser device 1 of FIG. 1 has a solid state laser medium 10 that is formed of GdVO₄ (Nd: GdVO₄) or YVO₄ (Nd: YVO₄) which is a vanadate-based material to which Nd ions (Nd³⁺) are added. It is preferable for the concentration of the Nd ions which are added to solid state laser medium 10 to be no greater than 3 at. %. As a result of this, the excitation light can be efficiently absorbed. Table 1 shows an example of the properties of solid state laser medium 10.

Table 1

TABLE 1

| | | | | Light-emission |
|---|---|---|---|---|
| | Concen- | Absorption properties | | properties |
| | tration | Absorption | Absorption | Light-emission |
| | of | wavelength | coefficient | wavelength |
| | added Nd | (nm) | (cm⁻¹) | (nm) |
| Nd: YVO₄ | 1.0 at. % | 879.8 | 36.1 | 914 |
| | | | | 1064.1 |
| Nd: GdVO₄ | 1.0 at. % | 879.6 | 22.2 | 912 |
| | | | | 1062.9 |

As shown in Table 1, solid state laser medium 10 has properties so as to absorb light having a wavelength of approximately 880 nm. Furthermore, in the case where the solid state laser medium 10 is formed of YVO₄, fluorescent light having a wavelength of approximately 914 nm and a wavelength of approximately 1064 nm is emitted. In addition, in the case where the solid state laser medium 10 is formed of GdVO₄, fluorescent light having a wavelength of approximately 912 nm and a wavelength of approximately 1063 nm is emitted.

In the present specification, a wavelength range of 880 nm±5 nm that includes the wavelength (for example, a wavelength of approximately 880 nm) of light that can be absorbed by solid state laser medium 10 is referred to as the first wavelength range. In addition, a wavelength range from 910 nm to 916 nm that includes the wavelength (for example, a wavelength of approximately 912 nm and a wavelength of approximately 914 nm) on the short wavelength side in the fluorescent light emitted by solid state laser medium 10 is referred to as the second wavelength range, and a wavelength range from 1060 nm to 1065 nm that includes the wavelength (for example, a wavelength of approximately 1064 nm) on the high wavelength side is referred to as the third wavelength range. Laser device 1 excites solid state laser medium 10 with light having a wavelength of approximately 880 nm in the first wavelength range of 880 nm±5 nm, so as to output light having a wavelength of approximately 914 nm (or approximately 912 nm) in the second wavelength range from 910 nm to 916 nm.

Solid state laser medium 10 has first surface 10A and second surface 10B which face each other, as shown in FIG. 1. Here, it is preferable for the thickness of solid state laser medium 10 in the direction perpendicular to first surface 10A and second surface 10B to be no greater than approximately 3 mm from the point of view of oscillation efficiency and heat radiation.

A high reflection film 12 that effectively reflects light having a wavelength in the first wavelength range of 880±5 nm and in the second wavelength range from 910 nm to 916 nm, in other words, that has a high reflectance for light having a wavelength in the first wavelength range and in the second wavelength range is formed on first surface 10A of solid state laser medium 10. It is preferable for the reflectance of high reflection film 12 for light having a wavelength in the first wavelength range and in the second wavelength range to be almost 100%.

A low heat resistance contact layer 14 and a heat sink 16 are sequentially provided on high reflection film 12 (on the left side in FIG. 1) starting from the high reflection film 12 side. Low heat resistance contact layer 14 may be formed of, for example, In (indium). As a result of this, heat generated by solid state laser medium 10 diffuses into heat sink 16.

In addition, an anti reflection film 18 that effectively transmits light having a wavelength in the first wavelength range and in the second wavelength range, in other words, that prevents reflection of light having a wavelength in the first wavelength range and in the second wavelength range, is formed on second surface 10B of solid state laser medium 10. Here, it is preferable for the transmittance of anti reflection film 18 for light in the first wavelength range and in the second wavelength range to be almost 100%.

Furthermore, laser device 1 has an output mirror (reflecting means) 20 that is placed in a position at a distance from second surface 10B in the direction normal to first surface 10A and second surface 10B of solid state laser medium 10, so as to form an optical resonator, together with high reflection film 12 on first surface 10A. As is understood from FIG. 1., output mirror 20 is placed approximately parallel to second surface 10B, and the optical axis of the optical resonator and the direction of a line normal to first surface 10A (or second surface 10B) approximately agree with each other. Output mirror 20 is a partially transmitting mirror where a coating film having predetermined reflection properties may be, for example, formed on a glass plate. A transmittance of approximately 10% can be cited to illustrate the predetermined reflection properties. The optical resonator is formed of high reflection film 12 and output mirror 20 in a manner where the Q-value for light having a wavelength in the second wavelength range is greater than the Q-value for light of every wavelength in the third wavelength range.

In addition, laser device 1 is provided with: a semiconductor laser element (excitation light source) 22 for outputting light having a wavelength of approximately 880 nm in the first wavelength range; a driving power supply 24 for driving semiconductor laser element 22; and a condensing optical system 26 for condensing light that has been outputted from semiconductor laser element 22 onto solid state laser medium 10.

Condensing optical system 26 is placed so that light from semiconductor laser element 22 enters into solid state laser medium 10 from anti reflection film 18 side on solid state laser medium 10 at an angle α between the direction of entrance of the light and the optical axis of the optical resonator that is no less than 5°, in other words, so that an angle α between the optical axis of condensing optical system 26 and the optical axis of the optical resonator becomes no less than 5°. Here, though angle α is no less than 5°, the range of the angle is not limited in general, as long as the excitation light is guided into the optical resonator in a direction that is different from the direction of the optical axis of the optical resonator, so as to enter into solid state laser medium 10. However, it is preferable for angle α to be no less than 5° from the point of view of, for example, other optical elements and the like which are arranged in laser device 1.

Here, laser device 1 is provided with other components for the performance of laser device 1 of which the descriptions are omitted, in addition to the above-described semiconductor laser element 22, driving power supply 24, condensing optical system 26, solid state laser medium 10, high reflection film 12, anti reflection film 18, low heat resistance contact layer 14, heat sink 16 and output mirror 20.

Next, the operation of the above-described laser device 1 is described. The below described solid state laser medium 10 is formed of Nd: YVO₄.

First, driving power supply 24 is operated so that a laser beam (excitation light) having a wavelength of approximately 880 nm for exciting solid state laser medium 10 is outputted from semiconductor laser element 22. The excitation light which has been outputted from semiconductor laser element 22 passes through condensing optical system 26 so as to enter into solid state laser medium 10 through anti reflection film 18. Electrons in solid state laser medium 10 are directly excited to the upper laser level by the light having a wavelength of approximately 880 nm that has entered so that light is spontaneously emitted. In other words, solid state laser medium 10 is excited by light having a wavelength of approximately 880 nm so that fluorescent light is emitted. This fluorescent light has a wavelength of approximately 914 nm and a wavelength of approximately 1064 nm. At this time, coating is applied so that the fluorescent light having a wavelength of approximately 914 nm that is closer to the excitation wavelength can be emitted more efficiently than the fluorescent light having a wavelength of approximately 1064 nm.

High reflection film 12 and anti reflection film 18 having the above-described reflection properties (transmittance properties) are formed on first surface 10A and second surface 10B of solid state laser medium 10, and therefore, the light having a wavelength of approximately 914 nm, which is to become an oscillation wavelength, and that has been emitted from solid state laser medium 10 is reflected from high reflection film 12. The light having a wavelength of approximately 914 nm and that has been reflected from high reflection film 12 passes through anti reflection film 18 so as to reach output mirror 20, and is partially reflected from output mirror 20 so as to be directed toward the solid state laser medium 10 side. Therefore, the light having a wavelength of approximately 914 nm from solid state laser medium 10 repeats reflections between output mirror 20 and high reflection film 12. Thus, at a certain point in time, an induced emission occurs within solid state laser medium 10 so that a laser beam having an oscillation wavelength of approximately 914 nm is outputted to the outside through output mirror 20. On the other hand, the Q-value of the optical resonator for light having a wavelength of approximately 1064 nm is smaller than that for light having a wavelength of approximately 914 nm, and therefore, an induced emission of light having a wavelength of approximately 1064 nm is restricted.

As described above, high reflection film 12 and anti reflection film 18 are formed on solid state laser medium 10, and the Q-value of the resonance for light having a wavelength in the second wavelength range is greater than the Q-value of the resonance for light having a wavelength in the third wavelength range in the optical resonator formed of high reflection film 12 and output mirror 20, and thereby, a parasitic oscillation of light having a wavelength of approximately 1064 nm is restricted in the optical resonator, while light having a wavelength of approximately 914 nm is emitted as a laser beam. Here, it is preferable for the Q-value of the resonance for light having a wavelength in the second wavelength range to be 10 or more times greater than the Q-value of the resonance for light of every wavelength in the third wavelength range in the optical resonator, from the point of view of an efficient and reliable laser oscillation of the light having a wavelength in the second wavelength range.

In laser device 1 according to the present embodiment, Nd: GdVO₄ or Nd: YVO₄ is utilized for solid state laser medium 10. Furthermore, electrons of solid state laser medium 10 are directly excited to the upper laser level using light having a wavelength of approximately 880 nm as the excitation light. In this case, the electrons do not pass through non-radiation transition process A, and therefore, generation of heat in solid state laser medium 10 is restricted, and an atomic quantum efficiency that exceeds approximately 96% can be implemented.

Furthermore, the absorption cross-section of light having a wavelength of approximately 880 nm in Nd: GdVO₄ or Nd: YVO₄ is greater than the absorption cross-section of light having a wavelength of approximately 885 nm enabling the direct excitation in Nd: YAG, and therefore, the light-emission efficiency in laser device 1 can be increased, in comparison with the case where Nd: YAG is directly excited. As described above, in the configuration of the above-described laser device 1, an increase in efficiency can be achieved, restricting generation of heat, and therefore, the cooling mechanism can be simplified; miniaturization can be expected; and an increase in the output can be achieved.

In the case where the excitation wavelength is approximately 880 nm and the oscillation wavelength is approximately 912 nm (or approximately 914 nm), a partial reflection coating must be applied to one of the pair of reflection mirrors that form the optical resonator, so as to transmit light having a wavelength of approximately 880 nm, while reflecting light having a wavelength of approximately 912 nm (914 nm) in accordance with a conventional end surface excitation system. However, since the wavelength of the excitation light and the oscillation wavelength are close in value, an efficient partial reflection coating is difficult to apply, and the cost of the coating becomes high.

In contrast to this, the excitation light is guided into the optical resonator in a direction shifted from the optical axis of the optical resonator so as to enter into solid state laser medium 10 in the present embodiment. Therefore, it is possible to apply a coating having similar reflection properties for the two wavelengths, the excitation wavelength and the oscillation wavelength, to high reflection film 12 and output mirror 20 as well as anti reflection film 18, which form the optical oscillator. Therefore, laser device 1 having a simple configuration can be implemented at low cost.

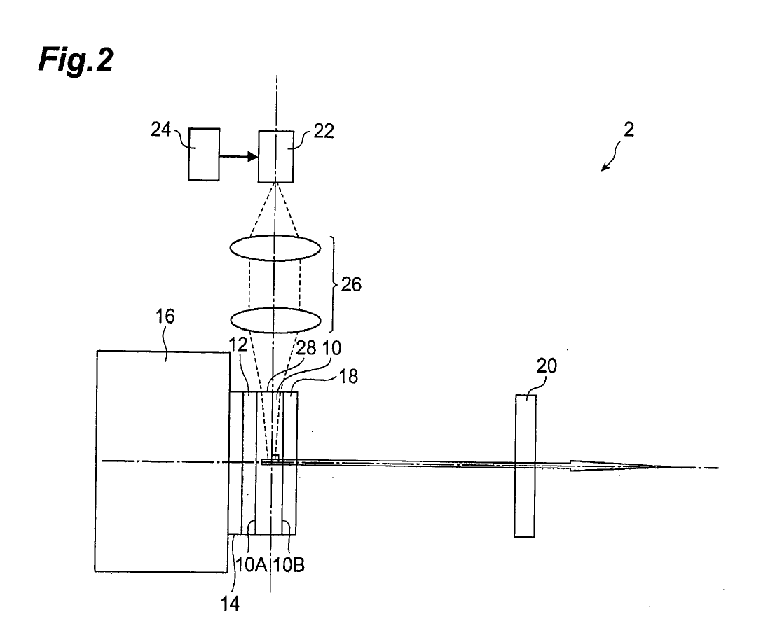

Next, a variety of modifications of the present embodiment are described. The present embodiment may have a configuration where the direction in which the excitation light enters into the optical resonator and the direction of the optical axis of the optical resonator are different from each other in general, that is to say, the direction of the optical axis of condensing optical system 26 and the direction of the optical axis of the optical resonator may be different from each other. For example, as in laser device 2 shown in FIG. 2, the angle between the direction in which the excitation light enters (the direction of the optical axis of condensing optical system 26) and the optical axis of the optical resonator may be approximately 90°, in other words, the excitation light may enter into end surface 28 which is adjoined to first surface 10A and second surface 10B of solid state laser medium 10.

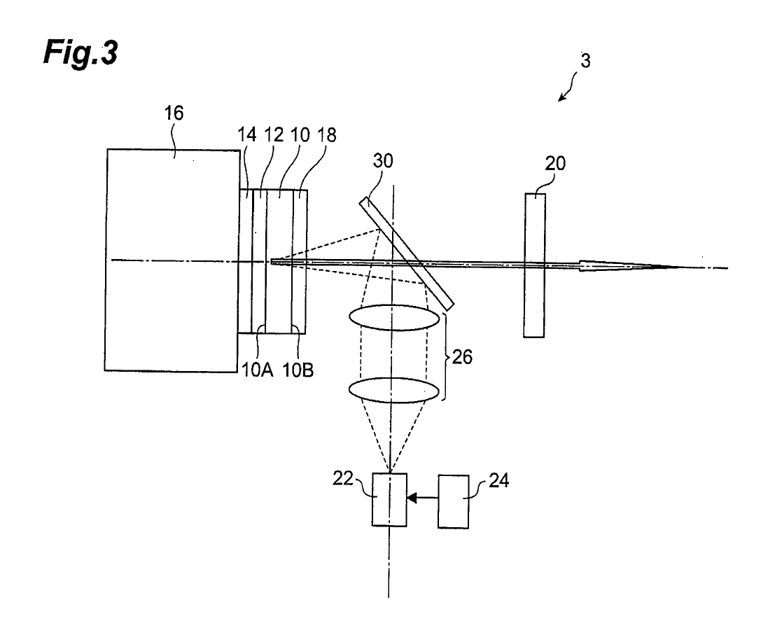

In addition, though the excitation light enters obliquely relative to the direction of a line normal to first surface 10A and second surface 10B of solid state laser medium 10 in the above-described preferred embodiment, it is not necessary for the excitation light to enter obliquely into solid state laser medium 10, but rather, the direction in which the excitation light enters into the optical resonator and the direction of the optical axis of the optical resonator may be different from each other, as described above. For example, it is possible for the system to allow the excitation light to enter in a manner such that it has approximately the same axis as the optical axis of the optical resonator by using a polarizing plate (optical path changing element) 30, as shown in FIG. 3. FIG. 3 is a schematic diagram showing a laser device 3 with polarizing plate 30 according to one modification of laser device 1. Laser device 3 has approximately the same configuration as laser device 1, except for the difference where laser device 3 is provided with polarizing plate 30.

As can be understood from FIG. 3, polarizing plate 30 is placed between anti reflection film 18 and output mirror 20 so that the optical path of the excitation light that is guided into the optical resonator in the direction approximately perpendicular to the optical axis of the optical resonator is changed to be in the direction of the optical axis of the optical resonator. Here, the excitation light may be polarized in the direction of a predetermined polarization (such as S polarization or P polarization) by means of the polarizing element, after the excitation light has been outputted from semiconductor laser element 22 and before it reaches polarizing plate 30. Here, the optical path changing element is not limited to the polarizing plate, but rather, it is possible to use a polarization beam splitter.

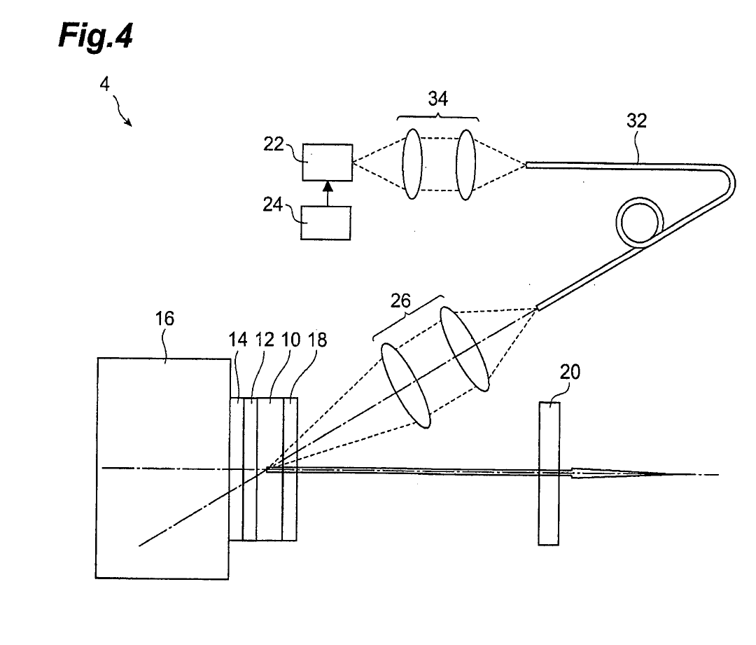

Furthermore, the system may allow the light that has been outputted from semiconductor laser element 22 to enter into an optical fiber so that the excitation light is guided into the optical resonator. FIG. 4 is a schematic diagram showing a laser device 4 with an optical fiber. Laser device 4 has the same configuration as laser device 1, except for the difference where laser device 4 is further provided with an optical fiber 32 and an entrance optical system 34 for allowing the light that has been outputted from semiconductor laser element 22 to enter into optical fiber 32, while laser device 1 is not provided with either. In this case, the light that has been outputted from semiconductor laser element 22 passes through entrance optical system 34 and enters into optical fiber 32. Then, the light is outputted from the other end of optical fiber 32 so as to enter into solid state laser medium 10 via condensing optical system 26, thus exciting solid state laser medium 10. The operation after solid state laser medium 10 has been excited is the same as in the case of laser device 1.

In the case where optical fiber 32 is used, the degree of freedom for the positioning of semiconductor laser element 22 is increased within laser device 4 so that the space within laser device 4 can be effectively utilized. Therefore, miniaturization of the laser device also becomes possible.

In addition, a plurality of optical fibers 32 may be used. In this case, a plurality of semiconductor laser elements 22 are placed in array form so that the light that has been outputted from each semiconductor laser element 22 enters into each optical fiber 32. Then, these optical fibers 32 are bundled in such a manner that the light which is outputted from one end of this bundle enters into solid state laser medium 10 via condensing optical system 26. In such a configuration, it is possible to excite solid state laser medium 10 with light from a plurality of semiconductor laser elements 22.

Furthermore, in the case where optical fiber 32 is used, condensing optical system 26 may be omitted. In this case, it is possible to place the output end of optical fiber 32, which outputs the excitation light from semiconductor laser element 22, in proximity of solid state laser medium 10, for excitation of the solid state laser medium. The direction in which the excitation light enters can be changed only by shifting the output end of optical fiber 32, and therefore, the system can allow the excitation light to enter into solid state laser medium 10 more easily in a variety of directions different from that of the optical axis of the optical resonator, than in the case where condensing optical system 26 is used.

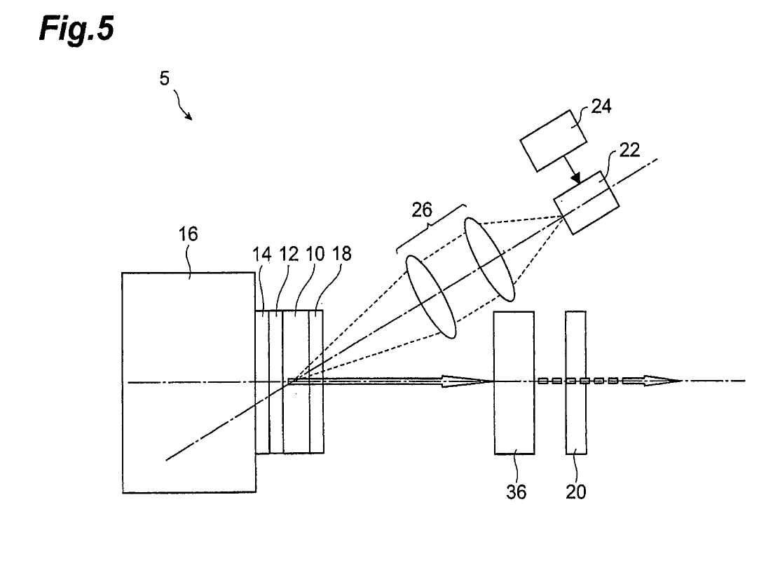

Furthermore, though continuous light is outputted from the above-described laser device 1, it is also possible for pulse light to be outputted, for example, by providing a pulse generation element 36 such as a saturable absorber, a photo-acoustic element or an electro-optic element on the optical axis between anti reflection film 18 and output mirror 20, as in laser device 5 of FIG. 5. Laser device 5 has approximately the same configuration as laser device 1, except for the difference where laser device 5 is provided with pulse generation element 36, while laser device 1 is not.

The operation in the case where pulse light outputted is described by citing an example of a case where a saturable absorber is placed as pulse generation element 36. A saturable absorber becomes transparent when the intensity of light is raised (absorption of light is reduced due to the saturation of absorption). Therefore, when solid state laser medium 10 is excited so as to emit light, this light is absorbed by a saturable absorber for absorbing light (having, for example, a wavelength of 914 nm) from solid state laser medium 10, in the case where the saturable absorber is placed within the optical resonator. The transmittance of the saturable absorber is increased together with such absorption, so that the saturable absorber becomes transparent.

In the case where the saturable absorber becomes transparent as described above, light having a wavelength of approximately 914 nm in the second wavelength range repeats the reflections between output mirror 20 and high reflection film 12 in the same manner as in the above-described case of laser device 1, in a manner where an induced emission occurs within solid state laser medium 10 at a certain point in time so that a laser beam is outputted to the outside through output mirror 20. Once the laser beam is outputted, accumulation of electrons in the excitation level is started in the saturated absorber. Accordingly, a laser beam is outputted periodically. That is to say, pulse light is obtained.

Here, though pulse generation element 36 is placed on the optical axis between anti reflection film 18 and output mirror 20 in FIG. 5, it may also be placed on the optical path of the light that is emitted from solid state laser medium 10 within laser device 5 in general.

Furthermore, though the light that is outputted from laser device 1 has a wavelength in the second wavelength range (for example, a wavelength of 912 nm or 914 nm), it is also possible to generate light having a different wavelength by placing a non-linear optical element (wavelength conversion element) on the optical path of the light that is emitted from solid state laser medium 10, and thus, utilizing a non-linear optical effect such as a higher harmonics generating process, parametric process, a sum frequency generating process or a differential frequency generating process.

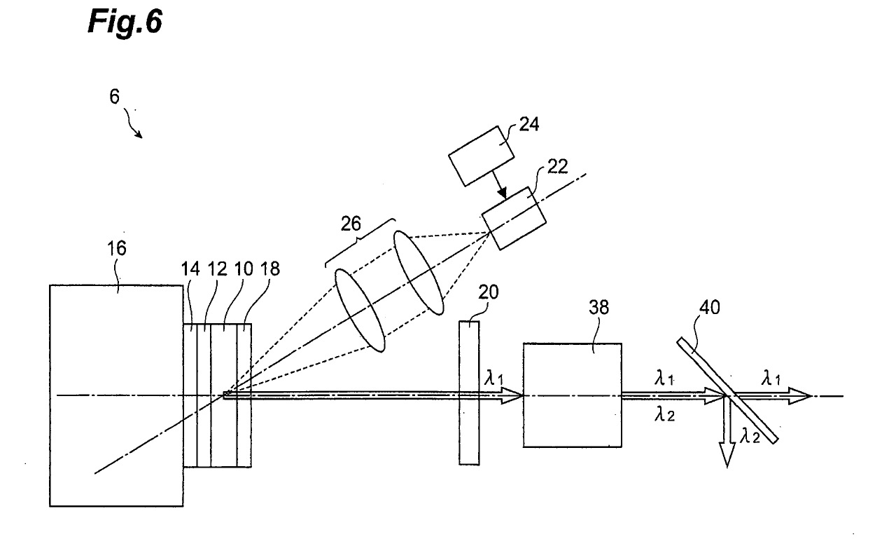

FIG. 6 is a schematic diagram showing a laser device 6 with a non-linear optical element 38. FIG. 6 is a schematic diagram showing laser device 6 in the case where the non-linear optical element (non-linear optical crystal) for generating the second higher harmonics generating process is placed on the optical axis of a laser beam outside of the optical resonator. In FIG. 6, in the case where the light having a wavelength λ₁ in the second wavelength range and that has been outputted from the optical resonator through output mirror 20 enters into the non-linear optical element, light having a wavelength of λ₂ is generated as a result of the second higher harmonics generating process so as to be outputted together with the light having wavelength λ₁. Since the light that is outputted from the non-linear optical element is composed of light having wavelength λ₁ and light having wavelength λ₂, it is possible to obtain two beams of light having different wavelengths by placing a beam splitter (or a filter) 40 or the like on the optical axis. Here, it is also possible to place the non-linear optical element within the optical resonator.

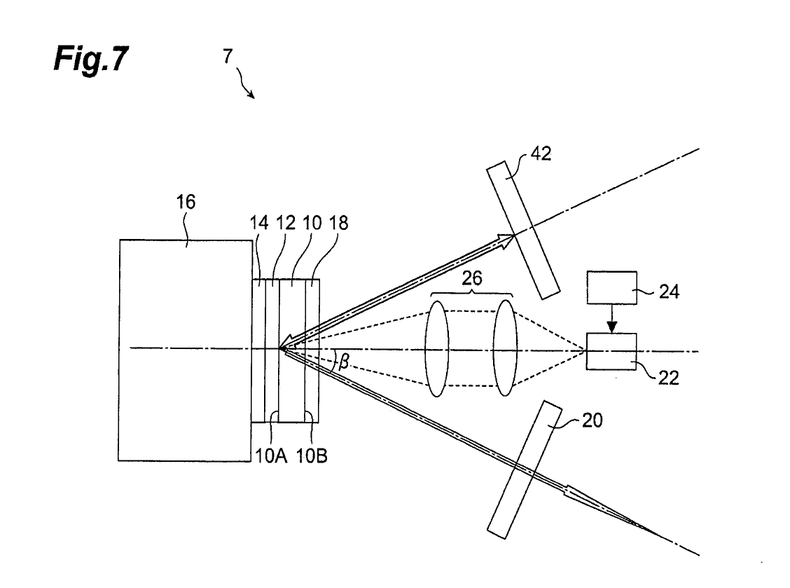

In addition, though first surface 10A (or second surface 10B) of solid state laser medium 10 and output mirror 20 are placed parallel to each other in laser device 1 of the above-described embodiment so as to form a linear type optical resonator, the invention is not necessarily limited to such a configuration. As shown in FIG. 7, for example, it is also possible to form a V-shaped optical resonator of high reflection film 12, output mirror 20 and reflecting mirror 42 by placing output mirror 20 and reflecting mirror 42 so as to be linearly symmetrical to each other, relative to a normal line of first surface 10A and second surface 10B of solid state laser medium 10. In addition, in the case where the direction of a normal line of first surface 10A and second surface 10B and the direction of the optical axis of the optical resonator are different from each other, as in the case of the V-shaped optical resonator, the length of solid state laser medium 10 in the direction of the optical axis of the optical resonator is preferably no greater than approximately 3 mM.

Here, concerning the reflection properties of reflecting mirror 42, the Q-value of the resonance for light having a wavelength in the second wavelength range may be greater than the Q-value of the resonance for light of every wavelength in the third wavelength range in the V-shaped optical resonator. FIG. 7 is a schematic diagram showing a laser device 7 having a V-shaped optical resonator. Laser device 7 has approximately the same configuration as laser device 1, except for the difference where the optical resonator in laser device 7 is in a V-shape, while that of laser device 1 is not.

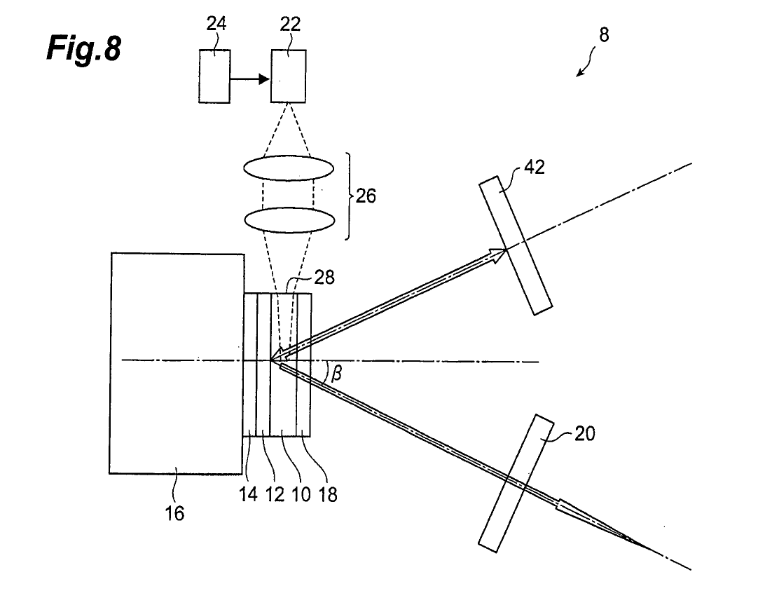

In such a case, the direction in which the excitation light enters into solid state laser medium 10 and the optical resonator (the direction of the optical axis of condensing optical system 26) may be different from the direction of the optical axis between high reflection film 12 and output mirror 20, forming an angle of, preferably, no less than 5°. In the case where an angle β between the direction of a normal line of first surface 10A and second surface 10B and the optical axis between high reflection film 12 and output mirror 20 is no less than 5°, for example, the system can allow the excitation light to enter in the direction of this normal line, as in laser device 7 of FIG. 7. In addition, in the case where the direction in which the excitation light enters into the optical resonator (the direction of the optical axis of condensing optical system 26) is different from that of the optical axis of the optical resonator so as to form an angle of, preferably, no less than 5°, the system may allow the excitation light to enter into solid state laser medium 10 through end surface 28, as in laser device 8 shown in FIG. 8. Laser device 8 has the same configuration as laser device 7, except for the difference where laser device 8 allows the excitation light to enter into solid state laser medium 10 through end surface 28 side.

Furthermore, it is also possible to form a Z-shaped optical resonator or a ring-shaped optical resonator in the case where the direction in which the excitation light enters into the optical resonator is shifted, and the Q-value of the optical resonator for light having a wavelength in the second wavelength range is greater than that for light of every wavelength in the third wavelength range.

In addition, though excitation light source 22 is a semiconductor laser element in laser device 1 of the above-described embodiment, the excitation light source may not necessarily be a semiconductor laser element, but rather may be any source that can output light having a wavelength in the first wavelength range of 880±5 nm that can excite solid state laser medium 10. Furthermore, though the semiconductor laser element is continuously oscillated in laser device 1, the semiconductor laser element may be pulse oscillated.

According to the present invention, a solid state laser medium made of GdVO₄ or YVO₄ to which Nd³⁺ is added can be excited with light having a wavelength in the first wavelength range of 880±5 nm, so as to laser oscillate light having a wavelength in the second wavelength range from 910 nm to 916 nm. As a result of this, it becomes possible to implement a high atom quantum efficiency that exceeds 96% and thus enhances the light-emission efficiency. Since it is possible to implement such a high atom quantum efficiency, heat generation can be restricted, making for a simple cooling mechanism for the solid state laser medium, and therefore, miniaturization of the laser device can be achieved, as well as an increase in the output.

1. A laser device comprising:
a solid state laser medium made of GdVO₄ or YVO₄ to which Nd³⁺ is added, having first and second surfaces facing each other;
a high reflection film formed on the first surface of said solid state laser medium for reflecting light having a wavelength in a first wavelength range of 880±5 nm, and light having a wavelength in a second wavelength range from 910 nm to 916 nm;
a reflecting means that is placed in a manner where an optical resonator of which the Q-value of the resonance for light having a wavelength in said second wavelength range is greater than the Q-value of the resonance for light of every wavelength in a third wavelength range from 1060 nm to 1065 nm is formed, together with said high reflection film, and said solid state laser medium is positioned within said optical resonator; and
an excitation light source that outputs light of a wavelength in said first wavelength range for exciting said solid state laser medium, wherein
light from said excitation light source is guided into said optical resonator in a direction different from the direction of the optical axis of said optical resonator so as to enter into said solid state laser medium.

2. The laser device according to claim 1, comprising an anti reflection film formed on the second surface of said solid state laser medium for transmitting light having a wavelength in said first wavelength range and light having a wavelength in said second wavelength range.

3. The laser device according to claim 1, wherein the Q-value of the resonance for light having a wavelength in said second wavelength range in said optical resonator is 10 or more times greater than the Q-value of the resonance for light of every wavelength in said third wavelength range in said optical resonator.

4. The laser device according to claim 1, wherein the concentration of Nd³⁺ in said solid state laser medium is no greater than 3 at.%.

5. The laser device according to claim 1, comprising an optical fiber for guiding light from said excitation light source to said optical resonator.

6. The laser device according to claim 1, comprising a condensing optical system for condensing light from said excitation light source onto said solid state laser medium.

7. The laser device according to claim 1, wherein the angle between the direction of light from said excitation light source entering into said solid state laser medium and the optical axis of said optical resonator is no less than 5°.

8. The laser device according to claim 1, comprising a optical path changing element, which is placed in the optical axis within said optical resonator, for changing the optical path of light from said excitation light source that has been guided into said optical resonator so that the light from said excitation light source enters into said solid state laser medium in approximately the same axis as the optical axis of said optical resonator.

9. The laser device according to claim 1, wherein the length of said solid state laser medium relative to the optical axis of said optical resonator is no greater than 3 mm.

10. The laser device according to claim 1, comprising a pulse generation element, which is placed on the optical path of the light that is emitted from said solid state laser medium, for generating a pulse light from the light that is emitted from said solid state laser medium.

11. The laser device according to claim 1, comprising a non-linear optical element, which is placed on the optical path of the light that is emitted from said solid state laser medium, for generating light having a wavelength that is different from the wavelength of the light that is emitted from said solid state laser medium by means of a non-linear optical effect from the light that is emitted from said solid state laser medium.
